(19) United States
(12) Patent Application Publication
(10) Pub. No.: US 2026/0037412 A1
(43) Pub. Date: Feb. 5, 2026

(54) AUTOMATED TEST SCRIPT GENERATION WITH MACHINE LEARNING BASED MAPPING OF TEST STEPS TO CODE FUNCTIONS

(71) Applicant: Dell Products L.P., Round Rock, TX (US)

(72) Inventors: Fangbin Zhou, Chengdu (CN); Yongmei Zhang, Chengdu (CN)

(21) Appl. No.: 18/799,014

(22) Filed: Aug. 9, 2024

(30) Foreign Application Priority Data
Aug. 5, 2024 (CN) 202411063920.8

(51) Int. Cl. G06F 11/36; G06N 3/0442

(52) U.S. Cl. CPC G06F 11/3684; G06N 3/0442

(57) ABSTRACT

An apparatus in an illustrative embodiment comprises at least one processing device that includes at least a processor and a memory coupled to the processor. The at least one processing device is configured to obtain test step information in natural language, to apply the test step information to a machine learning system configured to map the test step information to one or more code functions, to determine values for one or more parameters in the one or more code functions, and to execute the one or more code functions in a test script execution environment utilizing the determined values for the one or more parameters. The machine learning system in some embodiments comprises a long short-term memory (LSTM) neural network configured to receive a sequence of text tokens of the test step information and to map the sequence of text tokens to a particular code function.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### RELATED APPLICATION

The present application claims priority to Chinese Patent Application No. 202411063920.8, filed Aug. 5, 2024, and entitled “Automated Test Script Generation with Machine Learning Based Mapping of Test Steps to Code Functions,” which is incorporated by reference herein in its entirety.

### FIELD

The field relates generally to information processing, and more particularly relates to automated testing of devices and/or systems.

### BACKGROUND

Some testing of devices or systems illustratively involves backtracking and validation of development, aiming at comprehensively detecting possible defects, bugs, and any behaviors that are contrary to the expectations of a developed product (e.g., at least a portion of at least one device or system). Such tests may include multiple aspects such as case design, test environment setup, test execution, result analysis, and defect tracking.

By testing a product, various aspects of the product can be analyzed in depth, such as its performance, stability, security, and compatibility. In addition, test engineers can also examine the usability, interaction logic, and other aspects of the product from a user's perspective to see if there are any problems. The test feedback of the product is then provided to development teams, which helps them to further improve the product.

### SUMMARY

Illustrative embodiments of the present disclosure provide techniques for automated generation of test scripts with machine learning based mapping of test steps of one or more test cases to code functions, for use in automated testing of devices and/or systems as well as portions or combinations thereof.

In one embodiment, an apparatus comprises at least one processing device, with the at least one processing device comprising a processor and a memory coupled to the processor. The at least one processing device is configured to obtain test step information in natural language, to apply the test step information to a machine learning system configured to map the test step information to one or more code functions, to determine values for one or more parameters in the one or more code functions, and to execute the one or more code functions in a test script execution environment utilizing the determined values for the one or more parameters.

The machine learning system in some embodiments comprises a long short-term memory (LSTM) neural network configured to receive a sequence of text tokens of the test step information and to map the sequence of text tokens to a particular code function. A wide variety of other types of neural networks can be used.

In some embodiments, the above-noted determining of values for one or more parameters in the one or more code functions is implemented at least in part in two distinct phases comprising preparing one or more variables associated with the one or more code functions, and specifying values for the one or more parameters in the one or more code functions based at least in part on the prepared variables.

The machine learning system is trained in some embodiments utilizing a plurality of annotated test cases and corresponding test scripts that match respective ones of the test cases. For example, a given one of the test cases illustratively comprises test step information that includes a list of descriptive sentences each describing a corresponding test step of the given test case, and a given one of the test scripts illustratively comprises a list of code functions matching respective test steps of the given test case.

In some embodiments, at least one of the test cases comprises an automatically-generated test case with associated annotations each illustratively identifying a corresponding entity, operation or instance in a particular ontology.

Other illustrative embodiments include, by way of example and without limitation, methods and computer program products comprising non-transitory processor-readable storage media.

The foregoing arrangements are presented by way of illustrative example only, and should not be construed as limiting the scope of the present disclosure in any way.

### BRIEF DESCRIPTION OF THE DRAWINGS

FIG. 1 is a block diagram of an information processing system implementing functionality for automated test script generation with machine learning based mapping of test steps to code functions in an illustrative embodiment.

FIG. 2 is a flow diagram of an example process for automated test script generation with machine learning based mapping of test steps to code functions in an illustrative embodiment.

FIG. 3 shows example phases of a multi-phase process for automated test script generation with machine learning based mapping of test steps to code functions in an illustrative embodiment.

FIGS. 4A through 4E show examples of test step information and associated script code used to illustrate aspects of automated test script generation in illustrative embodiments.

FIG. 5 shows a portion of an example machine learning system implementing an LSTM neural network in an illustrative embodiment.

FIG. 6 shows a more detailed view of a portion of the LSTM neural network of FIG. 5.

FIG. 7 shows an example of the operation of a machine learning system implementing an LSTM neural network in an illustrative embodiment.

FIGS. 8 and 9 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that these and other embodiments are not restricted to the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, a wide variety of different arrangements of core-edge architectures comprising different types of core and edge infrastructure components. Numerous different types of enterprise and/or cloud computing and storage systems, as well as other systems and devices, are also encompassed by the term “information processing system” as that term is broadly used herein. A given information processing system may therefore comprise one or more processing devices, each comprising processor and memory components.

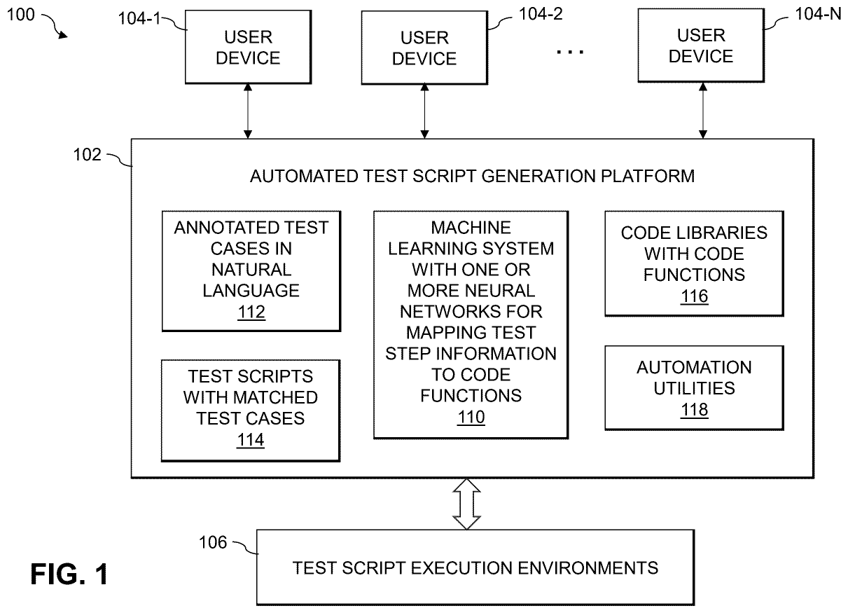

FIG. 1 shows an information processing system 100 configured with functionality for automated test script generation with machine learning based mapping of test steps to code functions in an illustrative embodiment. The information processing system 100 comprises an automated test script generation platform 102. The automated test script generation platform 102 is assumed to be implemented using one or more processing devices, as will be described in more detail below.

The system 100 further comprises a plurality of user devices 104-1, 104-2, . . . 104-N, collectively referred to herein as user devices 104, and a plurality of test script execution environments 106, where N is assumed to be an integer value greater than or equal to one, such that some embodiments may include only a single user device. The user devices 104 are illustratively implemented as respective computers or other types and arrangements of processing devices. Such processing devices can include, for example, desktop computers, laptop computers, tablet computers, mobile telephones, Internet of Things (IoT) devices, or other types of processing devices, as well as combinations of multiple such devices. One or more of the user devices 104 can additionally or alternatively comprise virtualized computing resources, such as virtual machines (VMs), containers, etc.

Although the user devices 104 are shown in the figure as being separate from the automated test script generation platform 102, this is by way of illustrative example only, and in other embodiments at least portions of the automated test script generation platform 102 may be implemented at least in part within one or more of the user devices 104.

Accordingly, in some embodiments, at least portions of the automated test script generation platform 102 may be implemented internally to one or more of the user devices 104. For example, each of the user devices 104 may incorporate at least portions of one or more machine learning systems of the automated test script generation platform 102. Numerous other operating scenarios involving a wide variety of different types and arrangements of processing devices are possible, as will be appreciated by those skilled in the art.

Also included in the system 100 are test script execution environments 106. The test script execution environments 106 execute the test scripts that are automatically generated by the automated test script generation platform 102, and may include a wide variety of different devices and/or systems that are configured to execute code of one or more test scripts, such as, for example, storage arrays or other storage systems comprising multiple storage clusters.

In some embodiments, the automated test script generation platform 102 may include one or more of the test script execution environments 106, or vice versa. Accordingly, although the test script execution environments 106 are shown in the figure as being external to the automated test script generation platform 102, this is by way of example only, and numerous alternative arrangements are possible. For example, in some embodiments, each of one or more of the test script execution environments 106 may be configured to include its own instance of an automated test script generation platform as described herein.

As shown in the figure, the automated test script generation platform 102 comprises a machine learning system 110. The machine learning system 110 comprises one or more neural networks for mapping test step information to code functions as will be described in greater detail elsewhere herein.

Also included in the automated test script generation platform 102 are annotated test cases 112 in natural language, and test scripts 114 with matched test cases. The annotated test cases 112 and the test scripts 114 in some embodiments are utilized for training the one or more neural networks of the machine learning system 110. Additionally or alternatively, at least a portion of the test scripts 114 may comprise test scripts that are automatically generated utilizing the machine learning system 110 and are suitable for execution in one or more of the test script execution environments 106.

It should be noted that the term “natural language” as used herein is intended to be broadly construed, so as to encompass, for example, a wide variety of different arrangements of descriptive information characterizing test steps of one or more test cases. The descriptive information is illustratively arranged in a manner that would be naturally used by humans to communicate such information. This may include, again by way of example, a sequence of descriptive sentences, each corresponding to a particular test step, where the term “sentence” as used in this context is also intended to be broadly construed, and should not be viewed as requiring any particular punctuation or grammatical constructs.

The automated test script generation platform 102 further comprises one or more code libraries 116 that include code functions used in automatically generating test scripts from test cases in the manner disclosed herein. The code libraries 116 in some embodiments are associated with automation utilities 118 of the automated test script generation platform 102. Such utilities are utilized in controlling at least portions of the automated generation of test scripts in the automated test script generation platform 102 and the execution of the generated test scripts in one or more of the test script execution environments 106.

The automated test script generation platform 102 of the system 100 in some embodiments may comprise at least a portion of one or more data centers. For example, the automated test script generation platform 102 may comprise, for example, at least one data center implemented at least in part utilizing cloud infrastructure. As other examples, the automated test script generation platform 102 in some embodiments may be implemented as or within a software-defined data center (SDDC), a virtual data center (VDC), or other similar dynamically-configurable arrangement. It is to be appreciated, however, that illustrative embodiments disclosed herein do not require the use of cloud infrastructure.

Additionally or alternatively, the automated test script generation platform 102 may comprise at least portions of one or more core nodes in a core-edge architecture that includes one or more core computing sites and one or more edge computing sites. The core computing sites may each comprise a plurality of servers or other types and arrangements of one or more core nodes. The edge computing sites may each comprise one or more edge stations or other types and arrangements of edge nodes. Each such node or other computing site comprises at least one processing device that includes a processor coupled to a memory.

The system 100 comprising the automated test script generation platform 102, the user devices 104 and the test script execution environments 106 is an example of what is more generally referred to herein as an “information processing system.” Other examples of information processing systems are described elsewhere herein, and the term is intended to be broadly construed to encompass, for example, various arrangements of one or more processing devices, with each such processing device comprising at least one processor and at least one memory coupled to the at least one processor.

Also, the term “user” herein is intended to be broadly construed so as to encompass numerous arrangements of human, hardware, software or firmware entities, as well as combinations of such entities.

Compute, storage and/or network services may be provided for users of the automated test script generation platform 102 of system 100 in some embodiments under a Platform-as-a-Service (PaaS) model, an Infrastructure-as-a-Service (IaaS) model, a Function-as-a-Service (FaaS) model and/or a Storage-as-a-Service (STaaS) model, although it is to be appreciated that numerous other arrangements could be used.

Although not explicitly shown in FIG. 1, one or more networks are assumed to be deployed in system 100 to interconnect the automated test script generation platform 102, the user devices 104 and the test script execution environments 106. Such networks can comprise, for example, a portion of a global computer network such as the Internet, a wide area network (WAN), a local area network (LAN), a satellite network, a telephone or cable network, a cellular network such as 4G or 5G network, a wireless network such as a WiFi or WiMAX network, or various portions or combinations of these and other types of networks. The system 100 in some embodiments therefore comprises combinations of multiple different types of networks. Such networks can support inter-device communications utilizing Internet Protocol (IP) and/or a wide variety of other communication protocols.

An example of the manner in which the automated test script generation platform 102 automatically generates test scripts will now be described in greater detail.

In this example, the automated test script generation platform 102 is configured to obtain test step information in natural language, to apply the test step information to the machine learning system 110 that is configured to map the test step information to one or more code functions, to determine values for one or more parameters in the one or more code functions, and to execute the one or more code functions in at least one of the test script execution environments 106 utilizing the determined values for the one or more parameters.

In some embodiments, the machine learning system 110 more particularly comprises a long short-term memory (LSTM) neural network, although additional or alternative neural networks of different types can be used in other embodiments.

The LSTM neural network in some embodiments comprises a plurality of inputs, a plurality of sequential computation stages coupled to respective ones of the inputs and generating respective hidden values, and at least one output. The inputs of the LSTM neural network are illustratively configured to receive respective text tokens in a sequence of text tokens of the test step information in natural language, and the output of the LSTM neural network illustratively comprises a particular code function mapped to the sequence of text tokens. Other LSTM configurations can be used in other embodiments.

In some embodiments, the above-noted determining of values for one or more parameters in the one or more code functions is carried out in two distinct phases, illustratively comprising a variable preparation stage, which involves preparing one or more variables associated with the one or more code functions, and a parameter fulfillment stage, which involves specifying values for the one or more parameters in the one or more code functions based at least in part on the prepared variables. Numerous other arrangements of one or more phases can be used to determine values for one or more parameters in the one or more code functions.

The machine learning system 110 in some embodiments is trained utilizing at least portions of the annotated test cases 112 and corresponding ones of the test scripts 114 that match respective ones of the annotated test cases 112.

In some embodiments, a given one of the test cases comprises test step information that includes a list of descriptive sentences each describing a corresponding test step of the given test case, and a given one of the test scripts comprises a list of code functions matching respective test steps of the given test case.

Additionally or alternatively, in some embodiments a given one of the test cases comprises an automatically-generated test case with associated annotations each illustratively identifying a corresponding entity, operation or instance in a particular ontology.

In some embodiments, the input to the machine learning system 110 comprises a sequence of test step descriptions of a given test case, and the output of the machine learning system 110 comprises a corresponding test script that includes a sequence of code functions. At least some of the code functions are illustratively part of one or more of the code libraries 116 associated with the automation utilities 118.

The above-described functionality of the automated test script generation platform 102 in some embodiments represents examples of one or more algorithms performed by the automated test script generation platform 102. Such an algorithm is illustratively implemented utilizing processor and memory components of at least one processing platform that includes at least one processing device. For example, at least portions of the machine learning system may be implemented at least in part in the form of software that is stored in memory and executed by a processor of one or more processing devices.

These and other features and functionality of the system 100 are illustratively implemented at least in part by or under the control of the automated test script generation platform 102.

It is to be appreciated that the particular arrangement of the automated test script generation platform 102, the user devices 104 and the test script execution environments 106 as illustrated in the FIG. 1 embodiment is presented by way of illustrative example only, and alternative arrangements can be used in other embodiments. As discussed above, for example, in some embodiments at least portions of the automated test script generation platform 102 may be implemented at least in part internally to one or more of the user devices 104 and/or the test script execution environments 106.

It is also to be understood that the particular set of elements shown in FIG. 1 for implementing automated test script generation platform 102 is presented by way of illustrative example only, and in other embodiments additional or alternative elements may be used. Thus, another embodiment may include additional or alternative systems, devices and other entities, as well as different arrangements of modules and other components.

As indicated previously, the automated test script generation platform 102, and possibly other portions of the system 100, may be implemented at least in part in cloud infrastructure.

The term “processing platform” as used herein is intended to be broadly construed so as to encompass, by way of illustration and without limitation, multiple sets of processing devices and associated storage systems that are configured to communicate over one or more networks. For example, distributed implementations of the system 100 are possible, in which certain components of the system reside in one data center in a first geographic location while other components of the system reside in one or more other data centers in one or more other geographic locations that are potentially remote from the first geographic location. Thus, it is possible in some implementations of the system 100 for different portions of the automated test script generation platform 102 to reside in different data centers or other different geographic locations. Numerous other distributed implementations are possible.

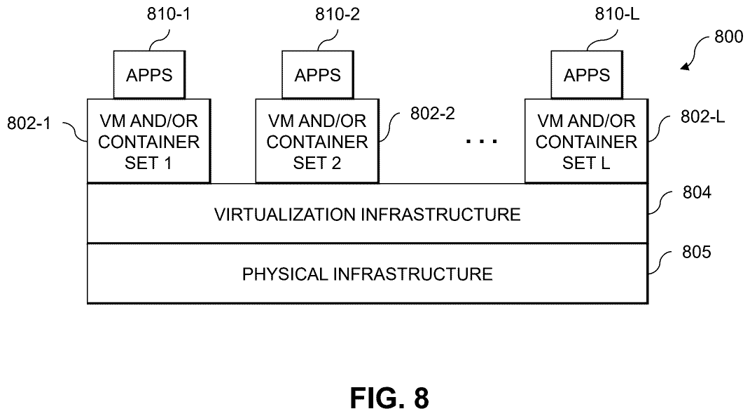

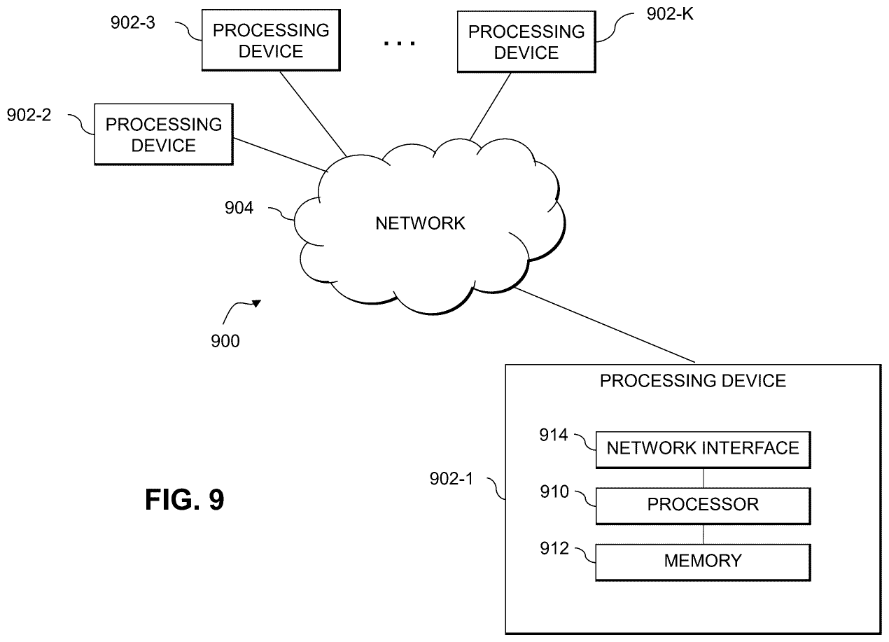

Additional examples of processing platforms that may be utilized to implement at least portions of the automated test script generation platform 102, the user devices 104 and the test script execution environments 106, and possibly additional or alternative components of the system 100 in illustrative embodiments will be described in more detail below in conjunction with FIGS. 8 and 9.

It is to be appreciated that these and other features of illustrative embodiments are presented by way of example only, and should not be construed as limiting in any way.

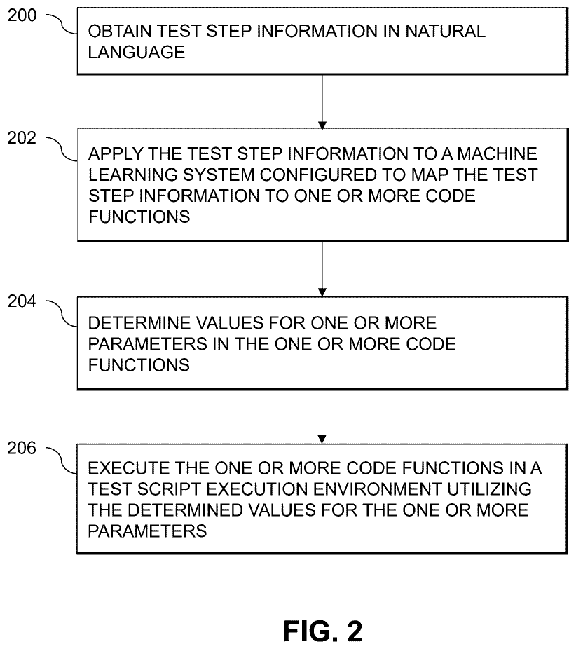

An exemplary process for automated test script generation will now be described in more detail with reference to the flow diagram of FIG. 2. It is to be understood that this particular process is only an example, and that additional or alternative processes for automated test script generation may be used in other embodiments.

In this embodiment, the process includes steps 200 through 206. These steps are assumed to be performed primarily by an automated test script generation platform such as automated test script generation platform 102, with additional involvement of one or more of the test script execution environments 106 and possibly also one or more of the user devices 104, although it is to be appreciated that other arrangements of system components can implement this or other similar processes in other embodiments. In some embodiments, the FIG. 2 process more particularly represents an example algorithm performed at least in part by one or more components of the automated test script generation platform 102 and at least one of the test script execution environments 106.

In step 200, test step information in natural language is obtained. For example, such test step information may be obtained by retrieving one or more existing test cases or portions thereof from a storage device or other type of memory associated with the automated test script generation platform. Additionally or alternatively, such test step information may be obtained at least in part through interaction with one or more users via their respective user devices. For example, a given user can provide natural language input to the automated test script generation platform via a user interface of a corresponding user device. Such natural language input can be in the form of a sequence of descriptive sentences that collectively provide at least a portion of at least one test case for which a test script is to be automatically generated. Other types of test step information can be obtained in other ways.

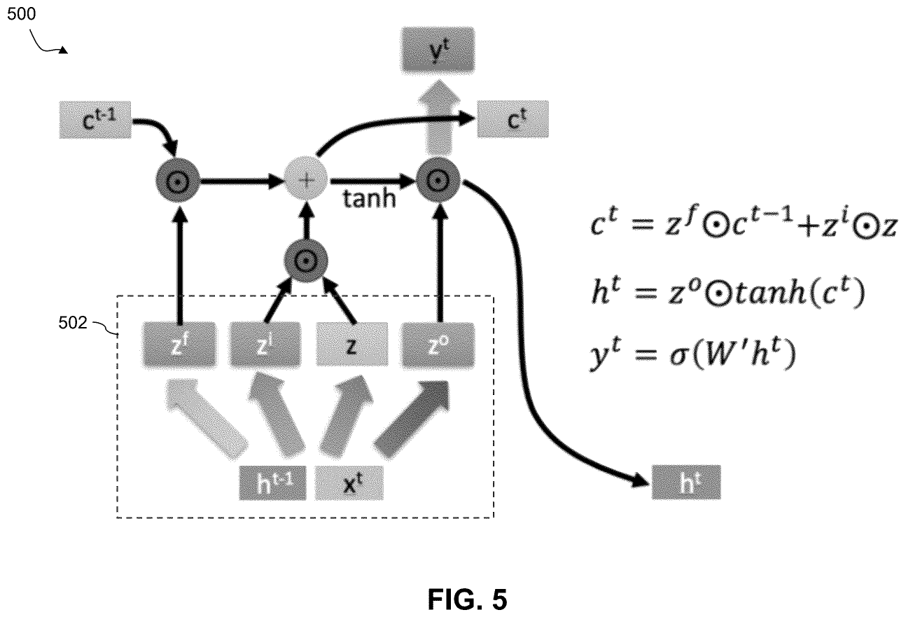

In step 202, the test step information is applied to a machine learning system configured to map the test step information to one or more code functions. As indicated above, the machine learning system in some embodiments comprises an LSTM neural network configured to receive a sequence of text tokens of the test step information and to map the sequence of text tokens to a particular code function. Examples of such an LSTM neural network will be described in more detail below in conjunction with FIGS. 5, 6 and 7. A wide variety of other types of neural networks can be used, including non-LSTM neural networks.

The machine learning system is trained in some embodiments utilizing a plurality of annotated test cases and corresponding test scripts that match respective ones of the test cases. For example, a given one of the test cases illustratively comprises test step information that includes a list of descriptive sentences each describing a corresponding test step of the given test case, and a given one of the test scripts illustratively comprises a list of code functions matching respective steps of the given test case.

In some embodiments, at least one of the test cases comprises an automatically-generated test case with associated annotations each illustratively identifying a corresponding entity, operation or instance in a particular ontology.

In step 204, values are determined for one or more parameters in the one or more code functions. In some embodiments, such a step is performed in multiple phases, such as a variable preparation phase and a parameter fulfillment phase, although numerous other arrangements can be used in other embodiments. The variable preparation phase illustratively involves preparing one or more variables associated with the one or more code functions, and the parameter fulfillment stage illustratively involves specifying values for the one or more parameters in the one or more code functions based at least in part on the prepared variables. Again, numerous other arrangements of different types and sequences of phases can be used.

In step 206, the one or more code functions are executed in a test script execution environment utilizing the determined values for the one or more parameters. Results of the execution of the test script are illustratively stored in a storage device or other memory associated with the automated test script generation platform, and at least portions of the results may be provided to one or more users via user interfaces of their respective user devices.

Multiple instances of the process of FIG. 2 can be performed in order to automatically generate multiple tests scripts for respective different test cases. Different ones of the automatically-generated test scripts can be executed in respective different test script execution environments.

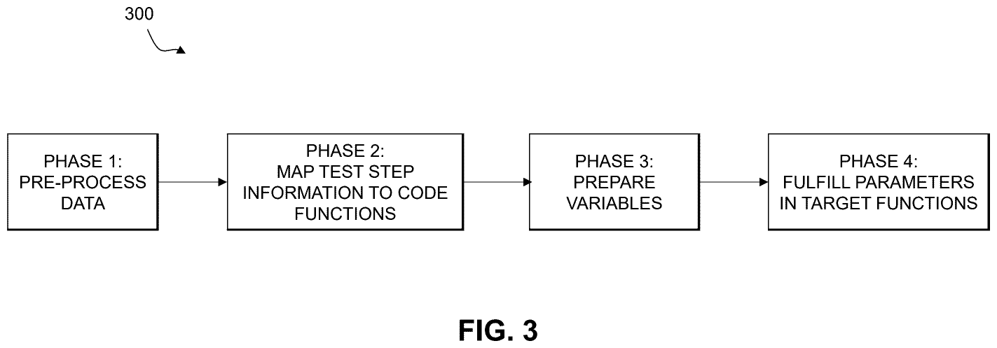

Further examples of the automated test script generation illustrated by the FIG. 2 process will be described in more detail below with reference to the illustrative embodiments of FIGS. 3 through 7.

The particular processing operations and other system functionality described in conjunction with the flow diagram of FIG. 2 are presented by way of illustrative example only, and should not be construed as limiting the scope of the disclosure in any way. Alternative embodiments can use other types of processing operations involving machine learning systems or other platform components and associated functionality for automated test script generation. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another in order to implement a plurality of different automated test code generation arrangements within a given information processing system.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Additional illustrative embodiments will now be described with reference to FIGS. 3 through 7. The particular details of these embodiments, like the other embodiments disclosed herein, and provided by way of example only, and should not be viewed as limiting the scope of the present disclosure in any way.

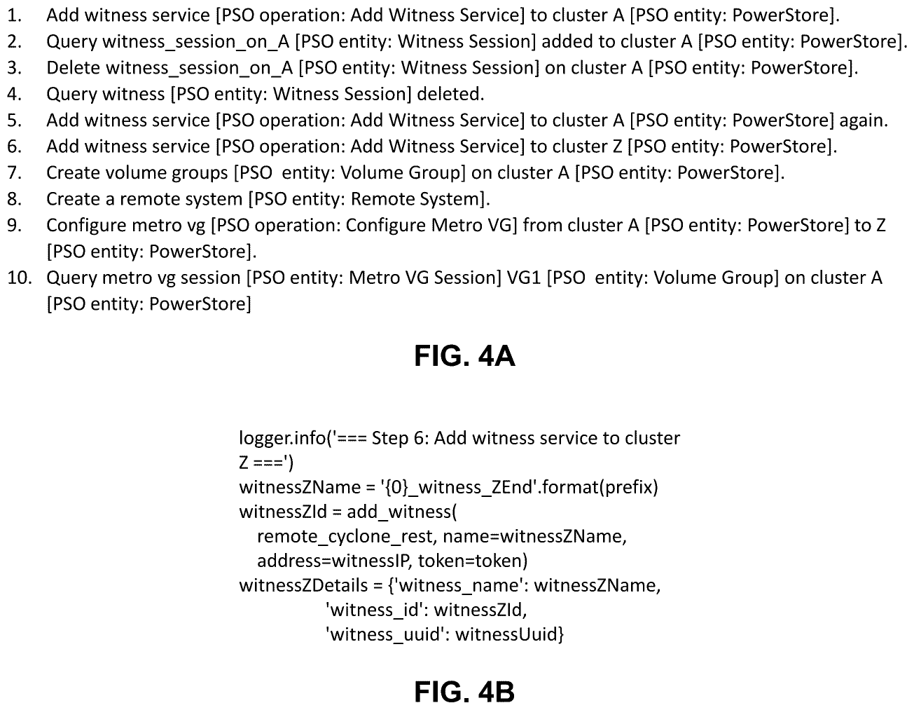

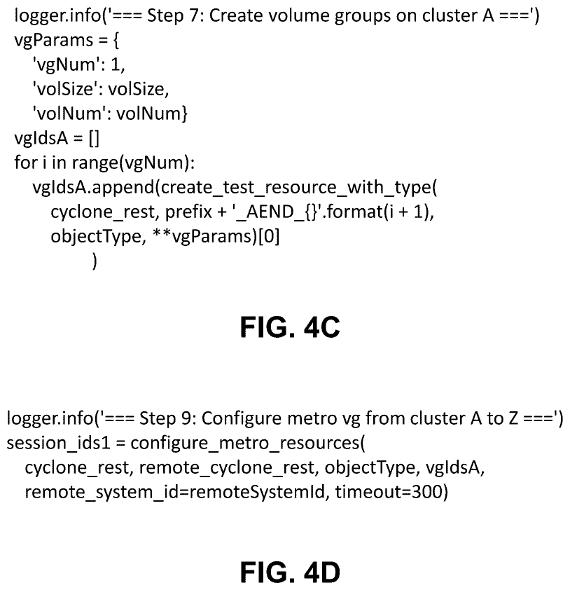

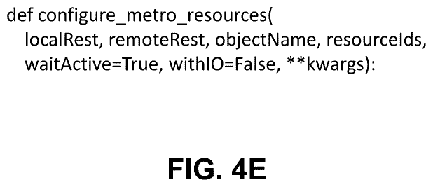

FIG. 3 shows example phases of a multi-phase process 300 for automated test script generation with machine learning based mapping of test steps to code functions in an illustrative embodiment. In this embodiment, the multi-phase process 300 includes four distinct phases, denoted Phase 1, Phase 2, Phase 3 and Phase 4, that respectively involve pre-processing data, mapping test step information to code functions, preparing variables and fulfilling parameters in target functions, each of which will be described in greater detail below. It is to be appreciated that additional or alternative phases can be used in other embodiments. For example, in some embodiments, Phase 3 and Phase 4 may be combined into a single phase, which more generally determines values for one or more parameters in the one or more code functions identified in Phase 2. Also, although the phases are shown in FIG. 3 as being sequential, in other embodiments one or more of the phases may at least partially overlap with one another. Example test step information and corresponding script code used to illustrate aspects of the various phases of the multi-phase process 300 are shown in FIGS. 4A through 4E, and will be referred to at various points in the following description.

### Pre-Process Data

Phase 1 of the multi-phase process 300 involves pre-processing of data. In some embodiments, each test case comprises a sequence of test steps in natural language. Each test step includes information such as one or more operations, target resource objects to operate on and results to be returned by the one or more operations.

In some embodiments, the test cases are in the form of automatically-generated test cases with associated annotations each illustratively identifying a corresponding entity, operation or instance in a particular ontology. For example, such test cases may be generated utilizing the techniques disclosed in U.S. patent application Ser. No. 18/650,971, filed Apr. 30, 2024, and entitled “Method, Electronic Device, and Computer Program Product for Test Case Generation,” which is incorporated by reference herein in its entirety. Some of these techniques utilize a particular storage system ontology to construct new test cases with associated annotations, illustratively referred to as a PowerStore Ontology (PSO), although other ontologies can be used in other embodiments. Additional ontology-related techniques that relate to generating configuration information of a storage system and that can be utilized in illustrative embodiments of the present disclosure include, for example, the techniques disclosed in U.S. Patent Application Publication No. 2022/0253467, entitled “Method, Device and Program Product for Generating Configuration Information of Storage System,” which is incorporated by reference herein in its entirety.

FIG. 4A shows example test step information of a test case with associated annotations utilizing the above-noted storage system ontology. The test case illustratively comprises a sequence of test steps in natural language, with each step including bracketed annotations identifying one or more entities or operations as shown, utilizing the above-noted PSO, which relates to an example storage system, illustratively comprising at least one PowerStore storage array from Dell Technologies Inc. Other types of storage systems and/or other devices and systems can be used in other embodiments. The entities in this example test case illustratively include one or more storage systems, as well as corresponding resources such as witness, volume group (“VG”) and metro VG session. The test step information of FIG. 4A is an example of what is more generally referred to herein as “test step information in natural language.” Such test step information in natural language is intended to be broadly construed, and may in some embodiments include one or more portions that are not necessarily in natural language, such as annotations relating to one or more ontologies. In other words, “test step information in natural language” as that term is broadly used herein is intended to encompass test step information that is primarily or at least partially in natural language. For example, the test step information in these and other embodiments may be primarily in natural language, where the latter term as used herein is also intended to be broadly construed.

The above-noted operations illustratively include actions that may be performed on entities, such as Add Witness Service and Configure Metro VG. Numerous other operations, as well as particular instances of entities on which such operations are performed, can be annotated in a similar manner in other embodiments. In embodiments in which the test steps of a given test case do not already include such annotations, the annotations may be added by a test engineer as part of the data pre-processing phase.

By way of example, if two volume groups VG1 and VG2 are created on the storage system, then VG1 and VG2 are instances of the volume group entity. As another example, in tests involving metro-related features of the storage system, which illustratively involve an active-active arrangement with two distinct storage clusters, one cluster is denoted as cluster A and the other is denoted as cluster Z, and by default cluster A is considered a local cluster and cluster Z is considered a remote cluster. Similarly, for tests involving replication of data between two storage arrays or other storage systems, one storage system is denoted as the source array and the other is denoted as the destination array. Numerous other types of annotations may be used in other embodiments.

Such annotations advantageously assist in the identification of variables in subsequent phases of the multi-phase process 300. For example, in traversing code to identify variables for fulfilling parameters, the annotations are illustratively used to determine variable types and instances. As a more particular example, if a given function needs a metro VG session list, the process can trace back to a step that previously creates such a session list. If the given function instead needs a particular specified session, the process can trace back to get the specified session, such as a session for volume group VG1.

The pre-processing of data in Phase 1 can additionally involve identifying relevant existing test scripts and their respective matched test cases, as well as one or more code libraries that include the code functions that are utilized by the test scripts.

### Map Test Step Information to Code Functions

Phase 2 of the multi-phase process 300 involves mapping test step information to code functions, as will now be described in greater detail.

Consider by way of example the operation Add Witness Service in step 6 of FIG. 4A. The environment in this example is cluster Z, the remote cluster, and the returned result is illustratively a corresponding witness session.

FIG. 4B shows example script code generated by the mapping of the test step information of step 6 to code functions. This script code illustratively implements the Add Witness Service operation.

As another example, consider the operation Create Volume Groups in step 7 of FIG. 4A. The environment in this example is cluster A, the local cluster. The returned result is illustratively a resource object with the type Volume Group.

FIG. 4C shows example script code generated by the mapping of the test step information of step 7 to code functions. This script code illustratively implements the Create Volume Groups operation.

As a further example, consider the operation Configure Metro VG in step 9 of FIG. 4A. The environment in this example is cluster A to cluster Z. The returned result in this example is a metro replication session identifier, illustratively denoted metro_replication_session_id.

FIG. 4D shows example script code generated by the mapping of the test step information of step 9 to code functions. This script code illustratively implements the Configure Metro VG operation.

The mapping of test step information to code functions in Phase 2 of the multi-phase process 300 illustratively utilizes a machine learning system that comprises an LSTM neural network, as described in more detail below.

A training data set for training the LSTM neural network illustratively comprises annotated test cases comprising lists of descriptive sentences in natural language for respective test steps, and corresponding test scrips comprising corresponding lists of code functions. The descriptive sentences in natural language illustratively include examples such as those in the above-noted steps 6, 7 and 9 of FIG. 4A, and the corresponding code functions are as shown in respective FIGS. 4B, 4C and 4D. These code functions illustratively include code functions such as add_witness ( ) in FIG. 4B and configure_metro_resources ( ) in FIG. 4D, among others.

The code functions are illustratively part of one or more code libraries implemented within or otherwise accessible to an automated test script generation platform. Such code libraries may be part of or otherwise associated with one or more automation utilities of the automated test script generation platform.

FIG. 5 shows a portion 500 of an example machine learning system implementing an LSTM neural network in an illustrative embodiment. As indicated above, this LSTM neural network is utilized in illustrative embodiments to map test step information to code functions in a machine learning system of an automated test script generation platform.

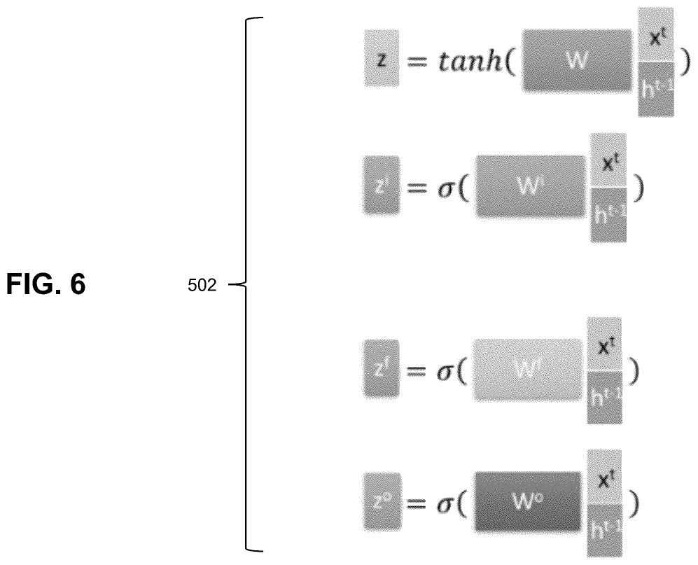

FIG. 6 shows a more detailed view of the computations performed in block 502 of the LSTM neural network of FIG. 5.

In this embodiment, each x^{t}, t=0,1, . . . n, is an input of the LSTM neural network, illustratively comprising a word from a test step description comprising n+1 words, each h^{t}, t=0, 1, . . . n, is a hidden state of the LSTM neural network, each c^{t}, t=0, 1, . . . n, is a cell state of the LSTM neural network, and the z, zⁱ, z^{o} and z^{f} are utilized in computing a cell state, where the superscripts i, o and f denote association with input, output and forget gates, respectively. FIG. 5 shows the operation of the LSTM neural network for a single value of x^{t}, where in the computations shown at the right side of the figure, ⊙ denotes Hadamard product and ⊕ denotes matrix addition, and FIG. 6 illustrates the manner in which z, zⁱ, z^{o} and z^{f} are computed from x^{t} and h^{t-1} values.

As shown in FIG. 5, the LSTM neural network for a single value of x^{t} performs the following computations:

$${c}^{t} = {z}^{f} ⊙ {c}^{t - 1} + {z}^{i} ⊙ z$$

$${h}^{t} = {z}^{o} ⊙ tanh ( {c}^{t} )$$

$${y}^{t} = σ ( {W}^{′} {h}^{t} )$$

where with regard to these computations of FIG. 5 and the additional computations of FIG. 6, tanh denotes a hyperbolic tangent function, W and its variants W′, Wⁱ, W^{o} and W^{f} denote respective weighting matrices, and o denotes a sigmoid function.

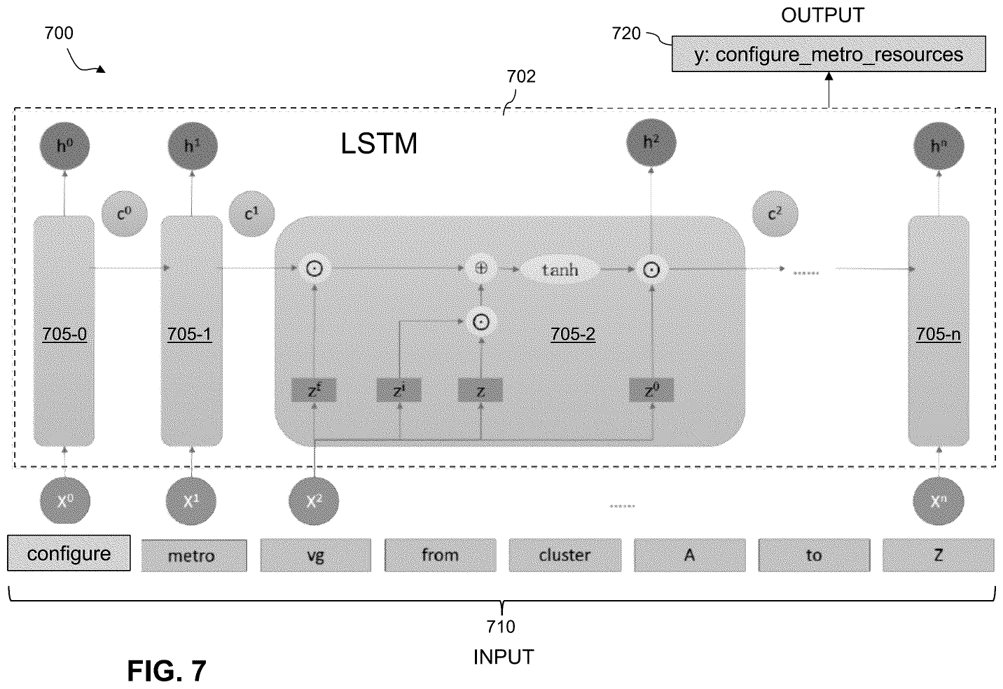

It is to be appreciated that this particular LSTM neural network configuration is presented by way of example only, and other types of LSTM neural networks, as well as a wide variety of different types of non-LSTM neural networks, may be used in other embodiments to map test step information to code functions as disclosed herein. 20 FIG. 7 shows a machine learning system 700 comprising an LSTM neural network 702 of the type described above in conjunction with FIGS. 5 and 6. The LSTM neural network 702 comprises n+1 computational stages denoted 705-0, 705-1, 705-2, . . . 705-n, and illustrates its operation in mapping an input 710 comprising test step information in natural language to an 25 output 720 comprising one or more code functions.

The input 710 comprises the test step information of step 9 of FIG. 4A. As previously described, this example input maps to the example script code of FIG. 4D. The input 710 more particularly comprises an entire descriptive sentence of step 9, shown as “configure metro vg from cluster A to Z.” Each word of this descriptive sentence, where acronyms, cluster names and the like are considered “words” as that term is broadly used herein, is applied to a different one of the n+1 inputs of the LSTM neural network 702. More particularly, as shown in the figure, input x⁰ is configure, input x¹ is metro, input x² is vg, . . . and input xⁿ is Z, where n=7 in this example, and y in output 720 denotes the mapped code function configure_metro_resources ( ) from FIG. 4D. The words of the input 710 collectively comprise an example of what is more generally referred to herein as a “sequence of text tokens.”

As indicated above, a training data set for training the LSTM neural network illustratively comprises annotated test cases comprising lists of descriptive sentences in natural language for respective test steps, and corresponding test scrips comprising corresponding lists of code functions. The descriptive sentences in natural language may include the above-noted steps 6, 7 and 9 of FIG. 4A, and the corresponding code functions may include the code functions shown in respective FIGS. 4B, 4C and 4D.

The training data set is used to train the LSTM neural network 702 in a training phase. Each of the descriptive sentences comprises an ordered set of inputs x^{t}, t=0, 1, . . . n, illustratively corresponding to at least one operation, and matches one or more code functions. A given test case therefore comprises multiple ordered sets of inputs x^{t} and its test script comprises a corresponding ordered set of outputs y, where FIG. 7 illustrates the generation of a single such output y for a given ordered set of inputs x^{t}. As indicated previously, the inputs illustratively comprise respective words of a given descriptive sentence, where such words are examples of what are more generally referred to herein as “text tokens” in test step information that comprises a sequence of text tokens.

In the training phase, the LSTM neural network 702 learns the relationships between test steps of test cases and code functions of the corresponding test scripts, utilizing the computations shown in FIGS. 5 and 6. For example, the LSTM neural network learns that the ordered set of inputs x^{t} comprising the descriptive sentence of step 9 of FIG. 4A maps to the code function configure_metro_resources ( ) from FIG. 4D, and similarly for other descriptive sentences mapping to other code functions.

### Prepare Variables

Phase 3 of the multi-phase process 300 involves preparing variables for the code functions identified in the previous mapping phase, illustratively by assigning values to one or more such variables. A given identified code function is referred to herein as the “target function” for the corresponding test step. The term “preparing variables” as used herein is intended to be broadly construed, so as to encompass various arrangements for specifying particular values for variables that are associated with a code function, and should not be viewed as limited in any way to the examples given below.

As one such example, referring again to FIG. 4D, after it is determined in Phase 2 that the function configure_metro_resources ( ) maps to the corresponding input descriptive sentence, Phase 3 prepares one or more variables, for use in fulfilling parameters in one or more target functions in subsequent Phase 4. Such variables in illustrative embodiments can be obtained in a number of different ways, including at least one or more of the following:
1. Obtained from testbed files. Typical testbed files used in test automation in the storage system context contain at least array information and host information. For example, a first array identified in a testbed file can be designated as cluster A, the local cluster, and a second array as cluster Z, the remote cluster. If more than two arrays are involved in a given test case, the additional arrays can be designated in accordance with similar naming conventions. Hosts in the storage system context can also be designated in a similar manner.
2. Obtained from test step descriptions. In the example of step 9 of FIG. 4A, the volume group or VG is a label that will be used in configure_metro_resources ( ) function of FIG. 4D to indicate that the test step is going to involve configuring a metro volume group. Accordingly, in this example, in which the LSTM neural network 702 returns the configure_metro_resources ( ) function at output 720 in response to the input 710, “volume” can be assigned as the value for the objectType variable of the function.
3. Obtained from previous step results. With continued reference to the example of step 9 of FIG. 4A, when configuring the metro volume group, variable values can include a volume group label, the volume group identifiers (IDs) returned from step 7 and the remote system ID returned from step 8.

### Fulfill Parameters in Target Functions

Phase 4 of the multi-phase process 300 involves fulfilling parameters in one or more target functions, illustratively by specifying values for parameters of the one or more target functions so as to make them executable in a test script execution environment. The term “fulfilling parameters” as used herein is intended to be broadly construed, so as to encompass various arrangements for specifying particular values for parameters of a code function, and should not be viewed as limited in any way to the examples given below.

With continued reference to the example test step information in step 9 of FIG. 4A, FIG. 4E shows the parameters of the function configure_metro_resources ( ) that is mapped to step 9 by the LSTM neural network 702. The LSTM neural network 702 identifies the function configure_metro_resources ( ) in Phase 2 of the multi-phase process 300, variables of the identified function are prepared in Phase 3 of the multi-phase process 300, and in Phase 4, the multi-phase process 300 fulfills the parameters of the identified function that are needed to make the function executable in a test script execution environment. As indicated above, the test script execution environment may comprise a storage system or set of multiple storage systems. Other types of test script execution environments can be used, and may comprise, for example, portions or combinations of one or more devices and/or systems.

In the example of FIG. 4E, the parameters include localRest, remoteRest, objectName, resourceIDs, waitActive status and withIO status. In accordance with the previously-described convention, cluster A is denoted as local and cluster Z as remote, each illustratively corresponding to a representational state transfer (“Rest”) object. Accordingly, the parameter localRest is fulfilled with cyclone_rest in FIG. 4D, and the parameter remoteRest is fulfilled with remote_cyclone_rest in FIG. 4D. As indicated previously, such parameters are illustratively obtained from testbed information, or using other techniques. The objectName in FIG. 4E is fulfilled with the objectType in FIG. 4D. This objectType is specified in the script as a volume group, which is a resource type in this example automation framework and is annotated as the entity volume group in one or more step descriptions. The resourceIDs in FIG. 4E are fulfilled using resource IDs obtained from previous step results, in this case the resource IDs returned from step 7. Similarly, the remote_system_id in FIG. 4D is obtained from the returned result of step 8. Such parameters in some embodiments may be annotated as instances, indicating the object on which the operation is performed.

Again, the particular modules and processing operations described in conjunction with the diagrams of FIGS. 3 through 7 are presented by way of illustrative example only, and should not be construed as limiting the scope of the disclosure in any way. Alternative embodiments can use other types of modules and processing operations to implement functionality for automated test script generation as disclosed herein.

As indicated previously, the illustrative embodiments disclosed herein can provide a number of significant advantages relative to conventional arrangements.

For example, illustrative embodiments of the present disclosure provide techniques for automated generation of test scripts with machine learning based mapping of test steps of one or more test cases to code functions.

Such embodiments can significantly improve the accuracy and efficiency of automated testing processes in a wide range of different contexts and applications.

For example, some embodiments use ontology-based descriptions to guide automated test script generation. The ontology-based descriptions illustratively contain logical and professional information associated with a given context or application.

As another example, some embodiments automatically align script code function sequence with test step sequence. More particularly, a given test case can comprise a sequence of ordered test steps in the form of respective description sentences, and the corresponding test script comprises ordered functions comprising operations that implement the corresponding description sentences.

Additionally or alternatively, illustrative embodiments are configured to automatically map a given description sentence for a test step in a test case to one or more script code functions. For example, in some embodiments, a test case comprises a set of description sentences for respective test steps. Such embodiments are illustratively configured to utilize machine learning to map each description sentence to one or more script code functions, resulting in a complete test script for the test case.

Illustrative embodiments also fill in the script code functions with parameter values so as to make the test scripts executable in test script execution environments.

These and other embodiments disclosed herein increase the accuracy and efficiency of test scripts through automated machine learning based generation of corresponding script code functions, thereby eliminating the drawbacks of conventional manual script generation, such as associated coding time and costs.

Such embodiments also avoid the drawbacks associated with conventional approaches utilizing large language models, such as generative pre-trained transformer (GPT) approaches, which typically require excessive manual interaction with test engineers. For example, a test engineer would need to conduct extensive interactions with a GPT to provide input prompts and interpret resulting responses in order to try to build a test script, leading to excessive test script generation time and costs.

Illustrative embodiments disclosed herein allow test scripts to be automatically generated in a wide variety of different programming languages, from natural language descriptions of test steps. Such arrangements can reduce the time and expense that would otherwise be required to train test personnel in new programming languages.

Also, the disclosed techniques are applicable to automated testing in numerous diverse fields and use cases.

Moreover, although illustrated herein using test steps with English-language descriptions, the disclosed techniques can be adapted in a straightforward manner for use with other languages, such as Chinese and many others.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement hosts and distributed storage systems with dynamic resource adjustment functionality will now be described in greater detail with reference to FIGS. 8 and 9. Although described in the context of system 100, these platforms may also be used to implement at least portions of other information processing systems in other embodiments.

FIG. 8 shows an example processing platform comprising cloud infrastructure 800. The cloud infrastructure 800 comprises a combination of physical and virtual processing resources that may be utilized to implement at least a portion of the information processing system 100. The cloud infrastructure 800 comprises multiple virtual machines (VMs) and/or container sets 802-1, 802-2, . . . 802-L implemented using virtualization infrastructure 804. The virtualization infrastructure 804 runs on physical infrastructure 805, and illustratively comprises one or more hypervisors and/or operating system level virtualization infrastructure. The operating system level virtualization infrastructure illustratively comprises kernel control groups of a Linux operating system or other type of operating system.

The cloud infrastructure 800 further comprises sets of applications 810-1, 810-2, . . . 810-L running on respective ones of the VMs/container sets 802-1, 802-2, . . . 802-L under the control of the virtualization infrastructure 804. The VMs/container sets 802 may comprise respective VMs, respective sets of one or more containers, or respective sets of one or more containers running in VMs.

In some implementations of the FIG. 8 embodiment, the VMs/container sets 802 comprise respective VMs implemented using virtualization infrastructure 804 that comprises at least one hypervisor. Such implementations can provide functionality for one or more aspects of automated test script generation of the type disclosed herein using one or more processes running on a given one of the VMs. For example, each of the VMs can include logic instances and/or other components for implementing at least portions of the disclosed automated test script generation in the system 100.

A hypervisor platform may be used to implement a hypervisor within the virtualization infrastructure 804. Such a hypervisor platform may comprise an associated virtual infrastructure management system. The underlying physical machines may comprise one or more distributed processing platforms that include one or more storage systems.

In other implementations of the FIG. 8 embodiment, the VMs/container sets 802 comprise respective containers implemented using virtualization infrastructure 804 that provides operating system level virtualization functionality, such as support for Docker containers running on bare metal hosts, or Docker containers running on VMs. The containers are illustratively implemented using respective kernel control groups of the operating system. Such implementations can also provide functionality for one or more aspects of automated test script generation of the type disclosed herein. For example, a container host supporting multiple containers of one or more container sets can include logic instances and/or other components for implementing at least portions of the disclosed automated test script generation in the system 100.

As is apparent from the above, one or more of the processing devices or other components of system 100 may each run on a computer, server, storage device or other processing platform element. A given such element may be viewed as an example of what is more generally referred to herein as a “processing device.” The cloud infrastructure 800 shown in FIG. 8 may represent at least a portion of one processing platform. Another example of such a processing platform is processing platform 900 shown in FIG. 9.

The processing platform 900 in this embodiment comprises a portion of system 100 and includes a plurality of processing devices, denoted 902-1, 902-2, 902-3, . . . 902-K, which communicate with one another over a network 904.

The network 904 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 902-1 in the processing platform 900 comprises a processor 910 coupled to a memory 912.

The processor 910 may comprise a microprocessor, a microcontroller, an application-specific integrated circuit (ASIC), a field-programmable gate array (FPGA), a graphics processing unit (GPU), a tensor processing unit (TPU) or other type of processing circuitry, as well as portions or combinations of such circuitry elements.

The memory 912 may comprise random access memory (RAM), read-only memory (ROM), flash memory or other types of memory, in any combination. The memory 912 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 902-1 is network interface circuitry 914, which is used to interface the processing device with the network 904 and other system components, and may comprise conventional transceivers.

The other processing devices 902 of the processing platform 900 are assumed to be configured in a manner similar to that shown for processing device 902-1 in the figure.

Again, the particular processing platform 900 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise various arrangements of converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for automated test script generation as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, processing devices, machine learning systems, neural networks, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to obtain test step information in natural language;
to apply the test step information to a machine learning system configured to map the test step information to one or more code functions;
to determine values for one or more parameters in the one or more code functions; and
to execute the one or more code functions in a test script execution environment utilizing the determined values for the one or more parameters.

2. The apparatus of claim 1 wherein the machine learning system comprises a long short-term memory (LSTM) neural network.

3. The apparatus of claim 2 wherein the LSTM neural network comprises a plurality of inputs, a plurality of sequential computation stages coupled to respective ones of the inputs and generating respective hidden values, and at least one output.

4. The apparatus of claim 3 wherein the inputs of the LSTM neural network are configured to receive respective text tokens in a sequence of text tokens of the test step information in natural language.

5. The apparatus of claim 4 wherein the output of the LSTM neural network comprises a particular code function mapped to the sequence of text tokens.

6. The apparatus of claim 1 wherein determining values for one or more parameters in the one or more code functions comprises:
preparing one or more variables associated with the one or more code functions; and
specifying values for the one or more parameters in the one or more code functions based at least in part on the prepared variables.

7. The apparatus of claim 1 wherein the machine learning system is trained utilizing a plurality of annotated test cases and corresponding test scripts that match respective ones of the test cases.

8. The apparatus of claim 7 wherein a given one of the test cases comprises test step information that includes a list of descriptive sentences each describing a corresponding test step of the given test case.

9. The apparatus of claim 7 wherein a given one of the test scripts comprises a list of code functions matching respective steps of a given one of the test cases.

10. The apparatus of claim 7 wherein a given one of the test cases comprises an automatically-generated test case with associated annotations each illustratively identifying a corresponding entity, operation or instance in a particular ontology.

11. A computer program product comprising a non-transitory processor-readable storage medium having stored therein program code of one or more software programs, wherein the program code when executed by at least one processing device causes the at least one processing device:
to obtain test step information in natural language;
to apply the test step information to a machine learning system configured to map the test step information to one or more code functions;
to determine values for one or more parameters in the one or more code functions; and
to execute the one or more code functions in a test script execution environment utilizing the determined values for the one or more parameters.

12. The computer program product of claim 11 wherein the machine learning system comprises a long short-term memory (LSTM) neural network.

13. The computer program product of claim 12 wherein the LSTM neural network is configured to receive a sequence of text tokens of the test step information and to map the sequence of text tokens to a particular code function.

14. The computer program product of claim 11 wherein the machine learning system is trained utilizing a plurality of annotated test cases and corresponding test scripts that match respective ones of the test cases.

15. The computer program product of claim 14 wherein a given one of the test cases comprises an automatically-generated test case with associated annotations each illustratively identifying a corresponding entity, operation or instance in a particular ontology.

16. A method comprising:
obtaining test step information in natural language;
applying the test step information to a machine learning system configured to map the test step information to one or more code functions;
determining values for one or more parameters in the one or more code functions; and
executing the one or more code functions in a test script execution environment utilizing the determined values for the one or more parameters;
wherein the method is performed by at least one processing device comprising a processor coupled to a memory.

17. The method of claim 16 wherein the machine learning system comprises a long short-term memory (LSTM) neural network.

18. The method of claim 17 wherein the LSTM neural network is configured to receive a sequence of text tokens of the test step information and to map the sequence of text tokens to a particular code function.

19. The method of claim 16 wherein the machine learning system is trained utilizing a plurality of annotated test cases and corresponding test scripts that match respective ones of the test cases.

20. The method of claim 19 wherein a given one of the test cases comprises an automatically-generated test case with associated annotations each illustratively identifying a corresponding entity, operation or instance in a particular ontology.
